(19) United States
(12) Patent Application Publication
(10) Pub. No.: US 2025/0084190 A1
(43) Pub. Date: Mar. 13, 2025

(54) COMPOSITIONS INCLUDING FUNCTIONALIZED SILYLATED POLYMERS, CURED COMPOSITIONS AND METHODS

(71) Applicant: BRIDGESTONE CORPORATION, Chuo-ku, Tokyo (JP)

(72) Inventors: Sem TAMANG, Stow, OH (US); Shammi AHMED, Copley, OH (US); Bret J. CHISHOLM, Peoria, IL (US)

(21) Appl. No.: 18/725,306

(22) PCT Filed: Dec. 29, 2022
(86) PCT No.: PCT/US2022/082529

§ 371 Date: Jun. 28, 2024

Related U.S. Application Data
(60) Provisional application No. 63/266,190, filed on Dec. 30, 2021.

(51) Int. Cl. C08C 19/25; C08K 3/04; C08K 3/36; C08L 7/00; C08L 9/00; C08L 9/06

(52) U.S. Cl. CPC C08C 19/25; C08K 3/04; C08K 3/36; C08L 7/00; C08L 9/00; C08L 9/06

(57) ABSTRACT

Polymer compositions including a silylated polymer derived from a polydiene polymer modified with a grafting agent including a silyl group and polar functional group. The polymer compositions are rubber blends that can be cured, wherein the silylated polymers aid in providing cured products thereof, such as tires, with improved properties. Methods for preparing the compositions and cured products such as tire components.

### FIELD OF THE INVENTION

The present invention relates to polymer compositions including a silylated polymer derived from a polydiene polymer modified with a grafting agent including a silyl group and functional group. The polymer compositions are preferably rubber blends that can be cured, wherein the silylated polymers aid in providing cured products thereof, such as tires, with improved properties including filler dispersion, lower rolling resistance, and improved snow traction. Methods for preparing the compositions and cured products such as tire components are disclosed.

### BACKGROUND OF THE INVENTION

Hydrosilylation as a methodology for functionalization is very well studied and has found wide-spread industrial application. It provides a facile way to incorporate silane functionality onto polymers. Silylated polymers have been utilized to produce cured polymer and rubber compositions.

WO 2015/091020 relates to a method for synthesizing a modified polymer including epoxide groups along the polymer chain, by a hydrosilylation reaction of the unsaturations with a hydrosilane having an epoxide function in the presence of a suitable catalyst. Functional polymers and crosslinkable compositions containing the same are also described.

U.S. Pat. No. 9,315,600 relates to a method for producing a modified conjugated diene polymer comprising a polymerization step of obtaining a conjugated diene polymer containing a nitrogen atom in a polymer chain and an active end by copolymerizing a conjugated diene compound and a nitrogen atom-containing vinyl compound, or a conjugated diene compound, an aromatic vinyl compound and a nitrogen atom-containing vinyl compound by use of an alkali metal compound and/or an alkaline earth metal compound as a polymerization initiator, and a modification step of reacting a modifier.

U.S. 2016/0369015 relates to backbone-modified elastomeric polymers to polymer compositions comprising such modified polymers, to the use of such compositions in the preparation of vulcanized polymer compositions, and to articles prepared from the same. The modified polymers are reportedly useful in the preparation of vulcanized, i.e. cross-linked, elastomeric compositions having relatively low hysteresis loss. Such vulcanized compositions are reportedly useful in many articles, including tire treads having low heat build-up, low rolling resistance, good wet grip and ice grip, in combination with other physical and chemical properties, for example, abrasion resistance and tensile strength. Moreover, the unvulcanized polymer compositions reportedly exhibit processability.

EP 3394119 relates to a diene elastomer, characterized in that it comprises units derived from diene distributed along the chain carrying a pendant group of the following formula (I): *-SiR1R2-A-B in which: A and B are such that the melting point of the non-hydrosilylated analog, HAB, is less than 70° C. and the elastomer comprises from 10 to 40% by weight of pendant groups of formula (I), relative to the total weight elastomer. A process for preparing such a diene elastomer, the compositions comprising it, in particular rubber compositions for tires, are disclosed.

### SUMMARY OF THE INVENTION

In view of the above, the art still needs curable polymer compositions including silylated polydiene polymers including multiple functional groups incorporated onto the backbone of the polymer. When the compositions are cured, improved properties are provided such as filler dispersion, lower rolling resistance, and improved snow traction. A template is provided for cured compositions having improved compound performance.

The compositions of the present invention in preferred embodiments include polymer blends comprising a silylated polydiene polymer and at least one non-silylated polydiene polymer. In other embodiments, the silylated polydiene polymer and at least one non-silylated polydiene polymer are derived from the same monomers. For example, in one embodiment the silylated polydiene polymer comprises repeat units derived from styrene and butadiene. Likewise, the non-silylated polydiene polymer also includes repeat units derived from styrene and butadiene.

In one embodiment, the silylated polydiene polymer is present in a minor amount by weight based on the total weight of the silylated polydiene polymer and the non-silylated polydiene polymer. In other embodiments, the opposite is true and the non-silylated polydiene polymer is present in a minor amount as compared to the silylated polydiene polymer derived from the same monomer units as the non-silylated polydiene polymer. In still other embodiments, the polymer composition includes equal amounts of silylated polydiene polymer and non-silylated polydiene polymer derived from the same monomer units.

In additional embodiments, the polymer compositions of the invention and cured products comprising the same are derived from a blend of different polymers, such as two or more polymers or three or more polymers or the like, wherein at least one of the polymers as a silylated polydiene polymer. As the silylated polydiene polymer carries pendant functional groups, which are preferably polar in some embodiments, improved filler dispersion is obtained for the composition as compared to the same composition without the silylated polydiene polymer. Each of the polymers utilized contributes desirable properties to the cured product, for example lower rolling resistance and improved snow traction as mentioned above, for example when the cured product comprises a tire tread. In some preferred embodiments, the polymer composition includes natural rubber, poly(butadiene), a copolymer of isobutene and isoprene (butyl rubber) and a styrene-butadiene copolymer, wherein at least one of the polymers include at least a portion thereof that has been silylated.

After curing, the products including the polymer compositions of the invention comprising the silylated polydiene polymer exhibit one or more of the following properties, as compared to a cured polymer composition without the silylated polydiene polymer: improved Payne Effect (AG′), Tan o at 60° C. and improved M300 at R.T. and 100° C. for samples aged at 100° C. for 1 day. The noted performance improvements are enhanced when the polymer composition includes a filler that is one or more of carbon black and silica.

According to one embodiment of the invention, a curable polymer composition is disclosed, comprising a silylated polydiene polymer comprising a reaction product of i) a polydiene and ii) a silylating grafting agent having the formula:

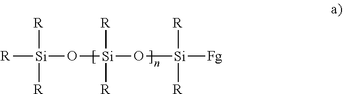

wherein n is an integer from 0 to 8, 25 or 150, and each R individually is a hydrogen atom, a halogen atom, Fg, or a monovalent organic group, or where two or more R groups join to form a bond or a polyvalent organic group, with the proviso that at least one R is a hydrogen atom;
wherein Fg is derived from a compound having the formula CH₂=C(R₁)(R₂), wherein at least one of R₁ and R₂ have a functionality that may participate in hydrogen bonding, a chemical reaction with a filler or polymer grafting and one of R₁, and R₂ may be a hydrogen atom or an organic group, wherein in one preferred embodiment the compound has the formula CH₂═CHCH₂X—R, wherein X is O, S or N, and wherein R is polyethylene oxide having from 3 to 100 repeat groups, or is derived from piperidine when X is N or is derived from bis(trimethylsilyl)amine when X is N, or

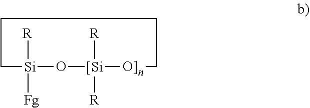

wherein R is a hydrogen atom, a halogen atom, Fg or a monovalent organic group, Fg is as defined above, and n is 2 to 5;
a non-silylated polydiene polymer comprising natural rubber; and a filler comprising one or more of carbon black and silica.

### DETAILED DESCRIPTION OF THE INVENTION

The curable polymer compositions, cured compositions, and cured products formed with the curable polymer composition comprise a silylated polydiene polymer comprising a reaction product of i) a polydiene and ii) a silylating grafting agent having the formula:

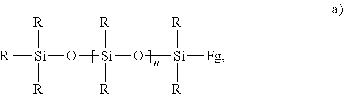

wherein n is an integer from 0 to 8, 25, or 150, and each R individually is a hydrogen atom, a halogen atom, Fg, or a monovalent organic group, or where two or more R groups join to form a bond or a polyvalent organic group, with the proviso that at least one R is a hydrogen atom; wherein Fg is derived from a compound having the formula CH₂=C(R₁)(R₂), wherein at least one of R₁ and R₂ have a functionality that may participate in hydrogen bonding, a chemical reaction with a filler or polymer grafting and one of R, and R₂ may be a hydrogen atom or an organic group, wherein in one preferred embodiment the compound has the formula CH₂═CHCH₂X—R, wherein X is O, S or N, and wherein R is polyethylene oxide having from 3 to 100 repeat groups, or is derived from piperidine when X is N or is derived from bis(trimethylsilyl)amine when X is N, or

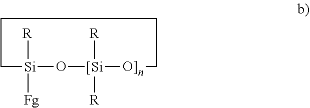

wherein R is a hydrogen atom, a halogen atom, Fg, or a monovalent organic group, Fg is as defined above, and n is 2 to 5;
a non-silylated polydiene polymer comprising one or more of natural rubber, styrene-butadiene copolymer and poly(1,3-butadiene); and a filler. The grafting agent grafted to polydiene polymer to produce the silylated polydiene polymer, in addition to possessing silicon atoms, includes a functional group, preferably polar in one embodiment, which can improve filler interaction within the composition blend and result in improved properties in the cured composition.

### Silylated Polydiene Polymer

### Synthesis of Silylated Grafting Agents

The silylating grafting agent is derived from a siloxane and a compound having a vinyl group with substitution at one carbon atom of the double bond which in some embodiments preferably is a polar compound comprising an allyl group reacted in the presence of a metal catalyst in an inert atmosphere.

### Siloxane

The siloxanes suitable for use in the present invention are characterized as including at least two hydrogen atoms which are covalently bonded to different silicon atoms. A first hydrogen atom participates in the reaction with the compound having a vinyl group with substitution at one carbon atom of the double bond which in some embodiments preferably is a polar compound comprising the allyl group and a second hydrogen atom participates in the hydrosilylation reaction with the polymer. In one or more embodiments, the siloxane is defined by the following formula:

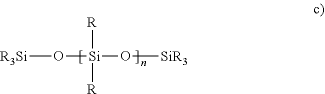

wherein n is an integer from 0 to 8, 25 or 150 and each R, individually, is a hydrogen atom, halogen atom, or a monovalent organic group, or where two or more R groups join to form a bond or a polyvalent organic group, with the proviso that each siloxane contains at least two R groups which are hydrogen atoms, bonded to different silicon atoms. In a preferred embodiment n is 0. In one or more embodiments, n is 1 to 4; or

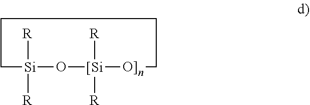

wherein R is a hydrogen atom, a halogen atom, or a monovalent organic group, and n is 2 to 5.

Non limiting examples of specific siloxanes include 1,1,3,3-tetramethyldisiloxane (TMDS), 1,1,3,3,5,5-hexamethyltrisiloxane, 1,1,3,3,5,5,7,7-octamethyltetrasiloxane, 1,1,1,3,5,7,7,7-octaakyltetrasiloxane, 1,1,3,3-tetraethyldisiloxane, 1,1,3,3,5,5-hexaethyltrisiloxane, 1,1,3,3,5,5,7,7-octaethyltetrasiloxane, 1,1,1,3,5,7,7,7-octaakyltetrasiloxane, 2,4,6,8-tetramethylcyclotetrasiloxane and 2,4,6-trimethylcyclotrisiloxane.

Compound with Vinyl Group

The compounds having a vinyl group with substitution at one carbon atom of the double bond is utilized to synthesize the grafting agent. In one embodiment the compound is a polar compound which comprises an allyl group which reacts with the siloxane under the reaction conditions. In one embodiment the compound has the formula CH₂=C(R₁)(R₂), wherein at least one of R₁ and R₂ have a functionality that may participate in hydrogen bonding, a chemical reaction with a filler or polymer grafting and one of R₁ and R₂ may be a hydrogen atom or an organic group. In a preferred embodiment, the polar compound has the formula: CH₂═CHCH₂—XR, wherein X is O, S or N, and wherein R is polyethylene oxide having from 3 to 100 repeat groups. In another preferred embodiment, the polar compound is derived from piperidine. In still another preferred embodiment, the polar compound is derived from bis(trimethylsilyl)amine.

### Grafting Agent Catalyst

Catalysts which make use of a hydrosilylation reaction are selected from organo metal compounds, salts or metals, wherein the metal is, for example, Ni, Ir, Rh, Ru, Os, Pd and Pt compounds as taught in U.S. Pat. Nos. 3,159,601; 3,159,662; 3,419,593; 3,715,334; 3,775,452 and 3,814,730, which are herein fully incorporated by reference. In one preferred embodiment, the catalyst is chloro(1,5-cyclooctadiene) rhodium (I) The catalyst may be added to the reaction mixture in any customary form, however, preferably in the form of a solution in a solvent.

### Solvent

The reaction which forms the grafting agent may be performed in a suitable solvent or solvents. Suitable organic solvents include aromatic hydrocarbons, aliphatic hydrocarbons, and cycloaliphatic hydrocarbons. Examples of suitable aromatic hydrocarbon solvents include, but are not limited to benzene, toluene, ethylbenzene, diethylbenzene, naphthalenes, mesitylene, xylenes, and the like. Examples of suitable aliphatic hydrocarbon solvents include, but are not limited to, n-pentane, n-hexane, n-heptane, n-octane, n-nonane, n-decane, isopentane, hexanes, isohexanes, isopentanes, isooctanes, 2,2-dimethylbutane, petroleum ether, kerosene, petroleum spirits, and the like. Non-limiting examples of suitable cycloaliphatic hydrocarbon solvents include cyclopentane, cyclohexane, methylcyclopentane, methylcyclohexane, and the like. Still other suitable solvents include polar, aprotic solvents, such as tetrahydrofuran. Mixtures of the foregoing aromatic hydrocarbon solvents, aliphatic hydrocarbon solvents, and cycloaliphatic hydrocarbon solvents and polar, aprotic solvents can also be used. In certain embodiments, the preferred organic solvent includes an aliphatic hydrocarbon solvent, a cycloaliphatic hydrocarbon solvent, or mixtures thereof. Additional useful organic solvents suitable for use in forming the grafting agent are known to those of ordinary skill in the art.

### Synthesis of Grafting Agents

A suitable reaction vessel is charged with a desired amount of siloxane and compound having a vinyl group with substitution of one carbon atom of the double bond. In one or more embodiments, a siloxane is used in a molar ratio in relation to the polar compound that ranges generally from greater than 1:1 to about 5:1, desirably greater than 1.25:1 to about 4:1 and preferably from about 1.5:1 to about 2.5:1, with 2:1 being most preferred. In one or more embodiments, the reaction vessel is cooled as the reaction is exothermic in nature. Thereafter, the catalyst, preferably in one embodiment dissolved in a suitable solvent, is added to the vessel. An inert atmosphere is utilized in one or more embodiments. Preferably the reaction mixture is agitated or otherwise mixed during reaction. The reaction mixture is allowed to warm up to a temperature, such as room temperature, or a temperature of about 25° C. to about 100° C. over a period of time such as about 3 to about 5 hours. The reaction vessel is vented during reaction to prevent excess buildup of H₂ gas.

If desired, additional steps can be implemented to remove the metal catalyst and purify the crude product. For example, after reaction, activated charcoal can be added to the reaction mixture and stirred for a period of time, for example about 1 hour in some embodiments. The mixture can then be passed over a pad of basic alumina with a hydrocarbon-based solvent as eluent, for example anhydrous pentane. The eluent can be further processed and concentrated under vacuo to yield the silylating grafting agent.

### Silylating Grafting Agent

The resulting silylating grafting agent has the formula:

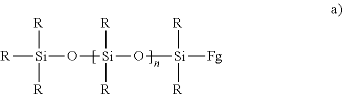

wherein each R and n are as defined hereinabove with the proviso that at least one R is a hydrogen atom; wherein Fg is derived from a compound having the formula CH₂=C(R₁)(R₂), wherein at least one of R₁ and R₂ have a functionality that may participate in hydrogen bonding, a chemical reaction with a filler or polymer grafting and one of R, and R₂ may be a hydrogen atom or an organic group, wherein in one preferred embodiment the compound has the formula CH₂═CHCH₂X—R, wherein X is O, S or N, and wherein R is polyethylene oxide having from 3 to 100 repeat groups, or is derived from piperidine when X is N or is derived from bis(trimethylsilyl)amine when X is N, or
wherein R is a hydrogen atom, a halogen atom, or a monovalent organic group, Fg is as defined above, and n is 2 to 5.
   Hydrosilylation of Polymer with Grafting Agent

The grafted polymer of the present invention is the reaction product of a polydiene polymer and the silylating grafting agent described herein. In addition to adding pendant silicon atoms to the polymer, the grafting agent also includes the herein-described functional group(s).

The polymer comprises pendant groups or unsaturations at one or more places on the main chain of the polymer. The term “graft” or the like as utilized herein should be understood to mean a pendant or side group fixed to the main chain of the polymer which arises from grafting by hydrosilylation of the grafting agent. Thus, according to the invention, the hydrosilane of the grafting agent reacts by hydrosilylation with the unsaturation of the polydiene polymer.

### Polydiene Polymer

When utilized herein, the term “polymer” is defined as a homopolymer, namely polymers formed from the same monomers, as well as a copolymer, namely polymers formed from two or more different monomers.

The ungrafted polymer, which is subjected to backbone modification in the present invention, is a homopolymer of a diene, or a copolymer of a first diene monomer and one or more second comonomers selected from a second diene monomer and aromatic vinyl compounds.

Examples of suitable dienes include, but are not limited to, (1,3-butadiene), 2-(C1-C5 alkyl)-1,3-butadiene such as isoprene (2-methyl-1,3-butadiene), 2,3-dimethyl-1,3-butadiene, 1,3-pentadiene, 2,4-hexadiene, 1,3-hexadiene, 1,3-heptadiene, 1,3-octadiene, 2-methyl-2,4-pentadiene, cyclopentadiene, 2,4-hexadiene, 1,3-cyclohexadiene and 1,3-cyclooctadiene. As noted above, two or more conjugated dienes may be utilized in combination to form the polymer. In one or more embodiments, butadiene is present in the polydiene.

Examples of aromatic vinyl compounds suitable for use in the polymer include monovinylaromatic compounds, i.e. compounds having a single vinyl group attached to an aromatic group, and di- or higher vinylaromatic compounds which have two or more vinyl groups attached to an aromatic group. Exemplary aromatic vinyl compounds include styrene, C1-C4 alkyl-substituted styrene such as 2-methylstyrene, 3-methylstyrene, 4-methylstyrene, 2,4-dimethylstyrene, 2,4,6-trimethylstyrene, alpha-methylstyrene, 2,4-diisopropylstyrene and 4-tert-butylstyrene, stilbene, vinyl benzyl dimethylamine, (4-vinylbenzyl)dimethyl aminoethyl ether, N,N-dimethylaminoethyl styrene, tert-butoxystyrene, vinylpyridine, and divinylaromatic compounds such as 1,2-divinylbenzene, 1,3-divinylbenzene and 1,4-divinylbenzene. Two or more aromatic vinyl compounds may be used in combination. A preferred aromatic vinyl compound is a monovinylaromatic compound, more preferably styrene.

In some embodiments, the aromatic vinyl compound constitutes from 5 wt. % to 50 wt. % and preferably from 10 wt. % to 45 wt. % of the total monomer content of the polymer.

Preferred polydiene polymers include styrene-butadiene rubber (SBR), poly(butadiene), butyl rubber (BR) and isoprene rubber (IR).

The polymers suitable for use in the present invention may be obtained according to conventional polymerization techniques utilizing conventional additives is well known to those of ordinary skill in the art. The polymers may for example be block, random, sequential or microsequential, and be prepared in dispersion, emulsion or solution, for example.

The polymerization can be conducted under batch, continuous or semi-continuous conditions. The polymerization process is preferably conducted as a solution polymerization, wherein the resulting polymer is substantially soluble in the reaction mixture, or as a suspension/slurry polymerization, wherein the polymer is substantially insoluble in the reaction medium. As the polymerization solvent, a hydrocarbon solvent is conventionally used which does not deactivate the initiator, catalyst or active polymer chain.

### Hydrosilylization of Polymer

In an important aspect of the present invention, the grafting of the grafting agent onto the polymer can take place in the polymerization solvent utilized to prepare the polymer. When this method is utilized, both time and expense are saved as the polymer need not be dried and subsequently resolvated prior to reaction with the grafting agent.

Preferably, the majority of the polymer chain ends, i.e. greater than 50%, especially at least 70%, preferably at least 80%, are terminated prior to the addition of the grafting agent; that is, living polymer chain ends are preferably not present and are not capable of reacting with the grafting. Termination of the polymer chain ends can be affected by the action of a coupling agent, quenching agent, or chain terminator, by chain-end functionalization or by other means, such as impurities in the polymerization process or by inter- or intra-chain reactions.

In one or more embodiments, a quenching agent can protonate a chain end of the living polymer. The quenching agent may include a protic compound, which includes, but is not limited to, an alcohol, a carboxylic acid, an inorganic acid, water, or a mixture thereof. An antioxidant such as 2,6-di-tert-butyl-4-methylphenol may be added along with, before, or after the addition of the quenching agent. In certain embodiments, the quenching agents and/or antioxidants are selected to limit interference with the hydrosilylation reaction. The amount of the antioxidant employed may be in the range of 0.2% to 1% by weight of the polymer.

In one or more embodiments, the living polymer can be terminated with a compound that will impart a functional group to the terminus of the polymer, thereby causing the resulting polymer to carry at least one additional functional group.

Useful terminating agents include those conventionally employed in the art. Non-limiting examples of compounds that have been used to end-functionalize living polymers include carbon dioxide, benzophenones, benzaldehydes, imidazolidones, pyrrolidinones, carbodiimides, ureas, isocyanates, and Schiff bases including those disclosed in U.S. Pat. Nos. 3,109,871, 3,135,716, 5,332,810, 5,109,907, 5,210,145, 5,227,431, 5,329,005, 5,935,893, which are incorporated herein by reference. Additional examples include trialkyltin halides such as tributyltin chloride, as disclosed in U.S. Pat. Nos. 4,519,431, 4,540,744, 4,603,722, 5,248,722, 5,349,024, 5,502,129, and 5,877,336, which are incorporated herein by reference. Other examples include cyclic amino compounds such as hexamethyleneimine alkyl chloride, as disclosed in U.S. Pat. Nos. 5,786,441, 5,916,976 and 5,552,473, which are incorporated herein by reference. Other examples include N-substituted aminoketones, N-substituted thioaminoketones, N-substituted aminoaldehydes, and N-substituted thioaminoaldehydes, including N-methyl-2-pyrrolidone or dimethylimidazolidinone (i.e., 1,3-dimethylethyleneurea) as disclosed in U.S. Pat. Nos. 4,677,165, 5,219,942, 5,902,856, 4,616,069, 4,929,679, 5,115,035, and 6,359, 167, which are incorporated herein by reference. Additional examples include cyclic sulfur-containing or oxygen containing azaheterocycles such as disclosed in U.S. Publication No. 2006/0074197 A1, U.S. Publication No. 2006/0178467 A1 and U.S. Pat. No. 6,596,798, which are incorporated herein by reference. Other examples include boron-containing terminators such as disclosed in U.S. Pat. No. 7,598,322, which is incorporated herein by reference. Still other examples include cyclic siloxanes such as hexamethylcyclotrisiloxane, including those disclosed in copending U.S. Publication No. 2007/0149744 A1, which is incorporated herein by reference. Further, other examples include α-halo-ω-aminoalkanes, such as 1-(3-bromopropyl)-2,2,5,5-tetramethyl-1-aza-2,5-disilacyclopentane, including those disclosed in U.S. Publication Nos. 2007/0293620 A1 and 2007/0293620 A1, which are incorporated herein by reference. Further examples include γ-mercapto-propyltrimethoxysilane, vinyltriethoxy silane, vinyltrimethoxy silane, and vinylmethyldimethoxy silane. Still further examples include 3-bis(trimethylsilyl) aminopropyl-methyldiethoxysilane and 3-(1,3-dimethylbutylidene)aminopropyltriethoxysilane. Additional terminators include trialkylsilyl halides, such as, but not limited to, trimethylsilyl chloride (TMSCI); triarylsilyl halides, such as, but not limited to, triphenylsilyl chloride; and a mixture of alkyl-arylsilyl halides, such as tert-butyldiphenylsilyl chloride, tris(Dimethylamino) chlorosilane, and 3-cyanopropylaminodimethylchlorosilane. The foregoing listing of terminating agents is not to be construed as limiting but rather as enabling. While a terminating agent can be employed, practice of the present invention is not limited to a specific agent or class of such compounds.

In one or more embodiments, the living polymer can be coupled to link two or more living polymer chains together. In certain embodiments, the living polymer can be treated with both coupling and terminating agents, which serve to couple some chains and terminate other chains. The combination of coupling agent and terminating agent can be used at various molar ratios. Although the terms coupling and terminating agents have been employed in this specification, those skilled in the art appreciate that certain compounds may serve both functions. That is, certain compounds may both couple and provide the polymer chains with a functional group. Those skilled in the art also appreciate that the ability to couple polymer chains may depend upon the amount of coupling agent reacted with the polymer chains. For example, advantageous coupling may be achieved where the coupling agent is added in a one to one ratio between the equivalents of a metal such as lithium on the initiator and equivalents of leaving groups (e.g., halogen atoms) on the coupling agent. Non-limiting examples of coupling agents include metal halides, metalloid halides, alkoxysilanes, and alkoxystannanes.

In one or more embodiments, metal halides or metalloid halides may be selected from the group comprising compounds expressed by the formula (1) R*ₙM¹Y₍₄₋ₙ₎, the formula (2) M¹Y₄, and the formula (3) M²Y₃, where each R* is independently a monovalent organic group having 1 to 20 carbon atoms, M¹ is a tin atom, silicon atom, or germanium atom, M² is a phosphorous atom, Y is a halogen atom, and n is an integer of 0-3.

Exemplary compounds expressed by the formula (1) include halogenated organic metal compounds, and the compounds expressed by the formulas (2) and (3) include halogenated metal compounds.

In the case where M¹ represents a silicon atom, the compounds expressed by the formula (1) can be, for example, triphenylchlorosilane, trihexylchlorosilane, trioctylchlorosilane, tributylchlorosilane, trimethylchlorosilane, diphenyldichlorosilane, dihexyldichlorosilane, dioctyldichlorosilane, dibutyldichlorosilane, dimethyldichlorosilane, methyltrichlorosilane, phenyltrichlorosilane, hexyltrichlorosilane, octyltrichlorosilane, butyltrichlorosilane, methyltrichlorosilane and the like. Furthermore, silicon tetrachloride, silicon tetrabromide and the like can be exemplified as the compounds expressed by the formula (2).

In the case where M¹ represents a germanium atom, the compounds expressed by the formula (1) can be, for example, triphenylgermanium chloride, dibutylgermanium dichloride, diphenylgermanium dichloride, butylgermanium trichloride and the like. Furthermore, germanium tetrachloride, germanium tetrabromide and the like can be exemplified as the compounds expressed by the formula (2). Phosphorous trichloride, phosphorous tribromide and the like can be exemplified as the compounds expressed by the formula (3). In one or more embodiments, mixtures of metal halides and/or metalloid halides can be used.

In one or more embodiments, alkoxysilanes or alkoxystannanes may be selected from the group comprising compounds expressed by the formula (4) R*ₙM¹(OR\hat{ })₄₋ₙ, where each R* is independently a monovalent organic group having 1 to 20 carbon atoms, M¹ is a tin atom, silicon atom, or germanium atom, OR\hat{ } is an alkoxy group where R\hat{ } is a monovalent organic group, and n is an integer of 0-3.

Exemplary compounds expressed by the formula (4) include tetraethyl orthosilicate, tetramethyl orthosilicate, tetrapropyl orthosilicate, tetraethoxy tin, tetramethoxy tin, and tetrapropoxy tin.

The addition of the grafting agent may be carried out before, after, or during the addition of a coupling agent (if used), and before, after, or during the addition of a chain end modifier (if used), and before, after, or during the addition of a chain terminator (if used). Preferably, the grafting agent is added after any addition of the coupling agent, the chain end modifier and the chain terminator.

The grafting agent may be directly added to the polymer solution (polymerization solution) without dilution (neat); however, it may be beneficial to add the grafting agent in solution. The amount of grafting agent added varies depending upon the monomer species, grafting agent species, reaction conditions and desired end properties, but is generally from about 1 wt. % to about 30 wt. %, desirably from about 2.5 wt. % to 20 wt. % and preferably from about 5 wt. % to about 15 wt. %, based on the weight of the polymer (i.e. unmodified polymer (homopolymer or copolymer) without any solvent, etc.

The hydrosilylation may be carried out in a temperature range of from generally from 50° C. to 120° C., desirably from 50° C. to 100° C., and preferably from 50° C. to 80° C.

There is generally no limitation for the duration and timing of the functionalization reaction. The polymer will be reacted with the grafting agent for a suitable period of time, as will be readily established by a person of ordinary skill in the art, generally ranging from about 0.5 hours to about 10 hours.

### Hydrosilylation Catalyst

The hydrosilylation reaction can be carried out as is known in the art and will usually be performed in the presence of a hydrosilylation catalyst. Two or more catalyst compounds may be used in combination. Catalysts as described above for producing the grafting agent can be utilized and are herein incorporated by reference. In one or more embodiments, preferred catalysts include Karstedt's catalyst. The catalyst may be added before, after or simultaneously with the addition of the grafting agent. The total amount of hydrosilylation catalyst will depend on the amount of grafting agent. At lower amount of the hydrosilylation catalyst, the conversion of the grafting agent may be too low, and higher amounts thereof may be economically disadvantageous.

### Polymerization/Hydrosilylation Solvent

As noted herein, polymerization of the monomers utilized to form the polydiene polymer is preferably performed in a solvent. In one or more embodiments, the hydrosilylation reaction is performed directly in the polymerization solvent. In other embodiments, a solvent other than or in addition to the polymerization solvent can be utilized.

Examples of solvents include, but are not limited to those solvents described hereinabove with respect to preparation of the grafting agent. Said solvents are herein incorporated by reference.

### Grafted Polymer

The degree of grafting may be adjusted in a manner known by one of ordinary skill in the art, by varying various operating conditions, for example the amount of molecules to be grafted, the reaction temperature and reaction time.

The reaction of the grafting agent with the polydiene polymer results in a pendant graft bearing a functional group connected to a silicon atom derived from the siloxane, such as TDMS.

More particularly, the pendant group attached to the backbone of the polymer has the following formula:

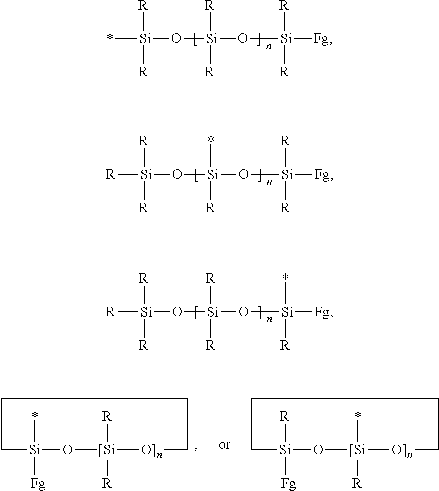

wherein R and Fg are as defined above and wherein * denotes a connection point with the polymer chain.

Generally, the average number of grafted units per chain is from about 0.25 to about 15, alternatively from about 2 to about 8. When the functional group includes ethylene oxide units, it has been found that grafting of the ethylene oxide units onto a main chain ranges generally from about 0.5 wt. % to about 10 wt. %, and preferably from about 0.6 wt. % to about 4.5 wt. %.

In embodiments where the functional group includes a nitrogen atom, grafting of nitrogen containing functional groups onto the main chain varies generally from about 50 ppm to about 2200 ppm N/chain.

In embodiments, the hydrosilyl-functionalized polydiene polymer may have a weight average molecular weight Mw of about 75,000 g/mol to about 1,000,000 g/mol. In embodiments, the functionalized conjugated diene may have a weight average molecular weight Mw greater than or equal to 75,000 g/mol, greater than or equal to 100,000 g/mol, greater than or equal to 200,000 g/mol, or even greater than or equal to 300,000 g/mol. In embodiments, the functionalized conjugated diene may have a weight average molecular weight Mw less than or equal to 1,000,000 g/mol, less than or equal to 800,000 g/mol, less than or equal to 600,000 g/mol, or even less than or equal to 400,000 g/mol. In embodiments, the functionalized conjugated diene polymer may have a molecular weight Mw from about 75,000 g/mol to about 1,000,000 g/mol, from about 75,000 g/mol to about 800,000 g/mol, from about 75,000 g/mol to about 600,000 g/mol, from about 75,000 g/mol to about 400,000 g/mol, from about 100,000 g/mol to about 1,000,000 g/mol, from about 100,000 g/mol to about 800,000 g/mol, from about 100,000 g/mol to about 600,000 g/mol, from about 100,000 g/mol to about 400,000 g/mol, from about 200,000 g/mol to about 1,000,000 g/mol, from about 200,000 g/mol to about 800,000 g/mol, from about 200,000 g/mol to about 600,000 g/mol, from about 200,000 g/mol to about 400,000 g/mol, from about 300,000 g/mol to about 1,000,000 g/mol, from about 300,000 g/mol to about 800,000 g/mol, from about 300,000 g/mol to about 600,000 g/mol, or even from about 300,000 g/mol to about 400,000 g/mol, or any and all sub-ranges formed from any of these endpoints. The weight average molecular weight Mw is determined by gel permeation chromatography using a Tosoh Ecosec HLC-8320 GPC system and Tosoh TSKgel GMHxI-BS columns with THE as a solvent. PS calibrated and referenced.

In embodiments, the hydrosilyl-functionalized polydiene polymer may have a number average molecular weight Mn of about 75,000 g/mol to about 1,000,000 g/mol. In embodiments, the functionalized conjugated diene may have a number average molecular weight Mn greater than or equal to 75,000 g/mol, greater than or equal to 100,000 g/mol, greater than or equal to 200,000 g/mol, or even greater than or equal to 300,000 g/mol. In embodiments, the functionalized conjugated diene may have a number average molecular weight Mn less than or equal to 1,000,000 g/mol, less than or equal to 800,000 g/mol, less than or equal to 600,000 g/mol, or even less than or equal to 400,000 g/mol. In embodiments, the functionalized conjugated diene polymer may have a molecular weight Mn from about 75,000 g/mol to about 1,000,000 g/mol, from about 75,000 g/mol to about 800,000 g/mol, from about 75,000 g/mol to about 600,000 g/mol, from about 75,000 g/mol to about 400,000 g/mol, from about 100,000 g/mol to about 1,000,000 g/mol, from about 100,000 g/mol to about 800,000 g/mol, from about 100,000 g/mol to about 600,000 g/mol, from about 100,000 g/mol to about 400,000 g/mol, from about 200,000 g/mol to about 1,000,000 g/mol, from about 200,000 g/mol to about 800,000 g/mol, from about 200,000 g/mol to about 600,000 g/mol, from about 200,000 g/mol to about 400,000 g/mol, from about 300,000 g/mol to about 1,000,000 g/mol, from about 300,000 g/mol to about 800,000 g/mol, from about 300,000 g/mol to about 600,000 g/mol, or even from about 300,000 g/mol to about 400,000 g/mol, or any and all sub-ranges formed from any of these endpoints. The number average molecular weight Mn is determined by gel permeation chromatography using a Tosoh Ecosec HLC-8320 GPC system and Tosoh TSKgel GMHxl-BS columns with THE as a solvent. PS calibrated and referenced.

### Non-Silylated Polydiene Polymer.

One or more non-silylated or non-grafted polydiene polymers are utilized in the polymer compositions of the invention. The polydiene includes carbon-carbon double bonds and thus are unsaturated and can be cured or vulcanized as known in the art.

The non-silylated polydiene polymers may be derived at least in part from conjugated or non-conjugated diene monomers. The amount of unsaturations along the chain will of course vary depending upon the specific polymers utilized.

Non-limiting examples of non-silylated polydiene polymers suitable for use in the present invention include, but are not limited to:
(a) a homopolymer obtained by polymerization of a conjugated diene monomer having from 4 to 12 carbon atoms;
(b) a copolymer obtained by copolymerization of a first conjugated diene monomer with one or more of a second different conjugated diene monomer and one or more ethylenically unsaturated monomers;
(c) a homopolymer obtained by polymerization of a non-conjugated diene monomer having from 5 to 12 carbon atoms;
(d) a copolymer obtained by copolymerization of a first non-conjugated diene and one or more of a second, different non-conjugated diene and one or more ethylenically unsaturated monomers;
(e) a ternary copolymer obtained by copolymerization of ethylene, an alpha-olefin having from 3 to 6 carbon atoms and a non-conjugated diene monomer having from 6 to 12 carbon atoms;
(f) a copolymer of isobutylene and isoprene, optionally halogenated;
(g) natural rubber;
(h) an unsaturated olefinic copolymer, the chain of which comprises at least olefinic monomer units, and diene units derived from at least one conjugated diene; or
(i) a mixture of two or more of (a) to (h) with one another.

Examples of suitable conjugated diene monomers useful for synthesizing polymers (a), (b) and (h), include, but are not limited to, 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene.

Examples of non-conjugated diene monomers suitable for synthesizing polymers (c), (d) and (e), include, but are not limited to 1,4-pentadiene, 1,4-hexadiene, ethylidenenorbornene and dicyclopentadiene.

Ethylenically unsaturated monomers able to be used in the copolymerization with one or more conjugated or non-conjugated diene monomers to synthesize copolymers (b) or (d), include, but are not limited to vinylaromatic compounds having from 8 to 20 carbon atoms, such as, for example, styrene, ortho-, meta- or para-methylstyrene, vinylmesitylene, divinylbenzene and vinylnaphthalene; vinyl nitrile monomers having 3 to 12 carbon atoms, such as, for example, acrylonitrile and methacrylonitrile; acrylic ester monomers derived from acrylic acid or methacrylic acid with alcohols having from 1 to 12 carbon atoms, such as, for example, methyl acrylate, ethyl acrylate, propyl acrylate, n-butyl acrylate, isobutyl acrylate, 2-ethylhexyl acrylate, methyl methacrylate, ethyl methacrylate, n-butyl methacrylate and isobutyl methacrylate.

Copolymers (b) or (d) may contain between 99% by weight and 1% by weight of diene units and between 1% by weight and 99% by weight of vinylaromatic, vinyl nitride and/or acrylic ester units.

Mono-olefin monomer suitable for synthesizing polymers (h), include, but are not limited to ethylene or an alpha-olefin having from 3 to 6 carbon atoms, for example propylene, butylene or isobutylene. Preferably, the mono-olefin monomer is ethylene, butylene and/or isobutylene.

According to certain embodiments, the olefinic copolymer (h) able to be used in the invention is a copolymer, the chain of which comprises olefinic monomer units, that is to say units derived from the insertion of at least one mono-olefin, and diene units derived from at least one conjugated diene. According to other embodiments, the units are not entirely units derived from diene monomers and mono-olefinic monomers. According to these embodiments, other units derived for example from an ethylenically unsaturated monomer as described above are present in the carbon-based chain. In some embodiments, the olefinic monomer units and polymer (h) are predominant, that is present at a molar content greater than 50% or more relative to the polymer.

Based on the above description, examples of suitable non-silylated polydiene polymers include, but are not limited to polybutadiene, polyisoprene or polychloroprene and their hydrogenated versions, polyisobutylene, block copolymers of butadiene and isoprene with styrene and their hydrogenated versions, such as poly(styrene-b-butadiene) (SB), poly(styrene-b-butadiene-b-styrene) (SBS), poly(styrene-b-isoprene-b-styrene) (SIS), poly [styrene-b-(isoprene-stat-butadiene)-b-styrene] or poly(styrene-b-isoprene-b-butadiene-b-styrene) (SIBS), hydrogenated SBS (SEBS), poly(styrene-b-butadiene-b-methyl methacrylate) (SBM) and also its hydrogenated version (SEBM), random copolymers of butadiene with styrene (SBR) and acrylonitrile (NBR) and their hydrogenated versions, random copolymers of isoprene with styrene (SIR) and their hydrogenated versions, random copolymers of isoprene and butadiene with styrene (SBIR) and their hydrogenated versions, butyl or halogenated rubbers, ethylene-propylene-diene terpolymers (EPDM), ethylene-diene copolymers and mixtures thereof.

In various preferred embodiments, the polydiene polymers are preferably, alone, or in combination, polybutadienes (abbreviated to “BR”), synthetic polyisoprenes (IR), natural rubber (NR), butadiene copolymers, isoprene copolymers, ethylene-diene copolymers and mixtures of these polymers. Such copolymers are more preferably selected from the group consisting of butadiene-styrene copolymers (SBR), isoprene-butadiene copolymers (BIR), isoprene-styrene copolymers (SIR), isoprene-butadiene-styrene copolymers (SBIR) and ethylene-butadiene copolymers (EBR).

The polymers suitable for use in the present invention may be obtained according to conventional polymerization techniques utilizing conventional additives is well known to those of ordinary skill in the art. The polymers may have any microstructure which is a function of the polymerization conditions used. The polymers may for example be block, random, sequential or microsequential, and be prepared in dispersion, emulsion or solution, for example. The polymerization can be conducted under batch, continuous or semi-continuous conditions.

The amount of non-silylated polydiene polymer in relation to the silylated polydiene polymer can vary depending upon end use application of the composition including the same. That said, in one or more embodiments, a curable polymer composition includes a majority of non-silylated polydiene polymer based on the total amount of non-silylated polydiene polymer and silylated polydiene polymer. In additional embodiments, the non-silylated polydiene polymer is present in an amount generally greater than 50 parts and preferably in an amount greater than 60 parts by weight based on 100 parts by weight of total polymer. In additional embodiments the silylated polydiene polymer is present in an amount from about 10 parts to about 50 or 75 parts based on 100 parts by weight of the silylated polydiene polymer and the non-silylated polydiene polymer or the silylated polydiene polymer is present in an amount from about 15 parts to about 35 parts based on 100 parts by weight of the silylated polydiene polymer and the non-silylated polydiene polymer.

### Fillers

In a preferred embodiment, the curable polymer compositions of the present invention include one or more fillers. Fillers serve as reinforcement agents in the polymer compositions and include, but are not limited to, carbon black, silica, carbon nanotubes, starch, aluminum hydroxide, magnesium hydroxide, clay, calcium carbonate, magnesium carbonate, a layered silicate and glass.

Carbon blacks include furnace blacks, channel blacks, and lamp blacks. More specific examples of carbon blacks include super abrasion furnace blacks, intermediate super abrasion furnace blacks, high abrasion furnace blacks, fast extrusion furnace blacks, fine furnace blacks, semi-reinforcing furnace blacks, medium processing channel blacks, hard processing channel blacks, conducting channel blacks, and acetylene blacks.

When utilized, carbon black is generally added in an amount from about 1 to about 40, 75, 100, or 110 parts, desirably in an amount from about 5 to about 38 parts and preferably in an amount from about 10 to about 35 parts by weight based on 100 parts by weight of total polymer.

Non-limiting examples of silica fillers include, but are not limited to wet process silica, dry process silica, synthetic silicate-type silica and combinations thereof. Silica with a small particle diameter and high surface area exhibits a high reinforcing effect. Small diameter, high agglomeration-type silica (i.e., having a large surface area and high oil absorptivity) exhibits excellent dispersibility in the polymer composition, representing desirable properties and superior processability. An average particle diameter of silica, in terms of a primary particle diameter, is in some embodiments from 5 to 60 nm, and in some embodiments from 10 to 35 nm. Moreover, the specific surface area of the silica particles (N2A, measured by the BET method) is in some embodiments from 35 to 300 m²/g. In some embodiments, the silica has a surface area of from 150 to 300 m²/g. Lower N2A values may lead to an unfavorably low reinforcing effect, whereas higher N2A values may provide a rubber compound with an increased viscosity and a deteriorated processability. For examples of suitable silica filler diameters, particle sizes and BET surface areas, see WO 2009/148932

Silica, when utilized is added in some embodiments in an amount generally from about 1 to about 30, 40, 100, or 120 parts, in some embodiments desirably from about 10 to 28 about parts, and in some embodiments preferably from about 12 to about 25 parts by weight based on 100 parts by weight of total polymer.

In some preferred embodiments, multiple different fillers, for example both carbon black and silica, are added together to the compositions, in which case the total amount of filler, ranges generally from about 1 to about 40, 75, 100, or 110 parts by weight and preferably from about 10 to about 35 parts by weight based on 100 parts by weight of total polymer.

### Optional Components

Other components or ingredients that may be employed in the polymer compositions of the present invention include, but are not limited to, oils, waxes, scorch inhibiting agents, processing aids, zinc oxide, tackifying resins, reinforcing resins, fatty acids such as stearic acid, peptizers, coupling agents, stabilizers and combinations thereof.

### Curing Agents

A multitude of rubber curing agents may be employed, including sulfur or peroxide-based curing systems. Curing agents are well known in the art and are, by way of non-limiting example, described in many volumes of the Kirk-Othmer Encyclopedia of Chemical Technology and Vulcanization in Encyclopedia of Polymer Science and Engineering, various editions, which are incorporated herein by reference. Curing agents may be used alone or in combination.

### Cured Polymer Composition

The cured polymer compositions of the present invention are obtained by curing or vulcanizing the uncured polymer composition describing herein which comprise one or more curing agents, under conditions and with machinery conventional known in the art.

Where the curable polymer compositions are employed in the manufacture of tires, these compositions can be processed into tire components according to ordinary tire manufacturing techniques including standard rubber shaping, molding and curing techniques. Typically, curing may be effected by heating the composition in a mold, for example to about 40 to about 180° C. Cured or crosslinked polymer compositions may be referred to as vulcanizates, which generally contain 3-dimensional polymeric networks that are thermoset. The other components of the compositions, such as fillers and processing aids are preferably evenly dispersed throughout the matrix or network.

### Articles Comprising Cured Polymer Composition

Since the cured polymer compositions of the invention exhibit properties including one or more of improved filler dispersion, low rolling resistance and improved snow traction, they are well suited for use in manufacturing, for example, tires or parts of tires including for example, tire treads, sidewalls, and other parts of tires as well as other industrial products such as belts, hoses, vibration dampers and footwear components.

Thus, articles of the present invention comprise at least one component formed from the cured polymer compositions of the invention. The article may be, for instance, a tire, a tire tread, a tire sidewall, a tire carcass, a belt, a gasket, a seal, a hose, a vibration damper, a golf ball or a footwear component, such as a shoe sole.

### EXAMPLES

The examples set forth below are provided to illustrate the silylating grafting agents, methods of synthesis thereof, polymers grafted therewith, compositions including the silylated polymers and methods for producing the same. The examples are not intended to limit the scope of the invention.

The following test protocols were used for testing:

TABLE 1

| Test | Units | Test Method |
|---|---|---|
| Number Average | Mn | Gel permeation chromatography (GPC) using a TOSOH |
| Molecular Weight | | Ecosec HLC-8320 GPC system and TOSOH TSKgel |
| | | GMHxI-BS columns with THF as a solvent. Calibrated |
| | | with PS standards and referenced to PS and BR |
| | | standards. |
| Weight Average | Mw | Gel permeation chromatography (GPC) using a TOSOH |
| Molecular Weight | | Ecosec HLC-8320 GPC system and TOSOH TSKgel |
| | | GMHxI-BS columns with THE as a solvent. Calibrated |
| | | with PS standards and referenced to PS and BR |
| | | standards. |
| Peak Molecular | Mp | Gel permeation chromatography (GPC) using a TOSOH |
| Weight | | Ecosec HLC-8320 GPC system and TOSOH TSKgel |
| | | GMHxI-BS columns with THE as a solvent. Calibrated |
| | | with PS standards and referenced to PS and BR |
| | | standards. |
| Styrene Content | wt. % | 400 MHz NMR using CDCL₃ as solvent |
| Vinyl Content | wt. % | 400 MHz NMR using CDCl₃ as solvent |
| 1,2 butadiene content | wt. % | 400 MHz NMR using CDCl₃ as solvent |
| Mooney viscosity | (ML1 + 4) | 100° C. with Monsanto Mooney viscometer with a large |
| | | rotor, one minute warm-up time, and a four-minute |
| | | running time |
| Nitrogen content | ppm | (3x) coagulated samples using a Mitsubishi Chemical |
| | | Analytech NSX-2100 Element Analyzer System |

### Synthesis of TMDS-propylpiperidine

A 100 mL oven dried three neck flask was charged with 1-allylpiperidine (5 g, 0.04 mols), 1,1,3,3-tetramethyldisiloxane (10.7 g, 0.08 mols), chloro(1,5-cyclooctadiene) rhodium (I) (5 mg, 0.01 mols) dissolved in anhydrous toluene (1 mL), and a stir bar under an inert atmosphere. The flask was vented during reaction to prevent buildup of H₂ gas. The color of the reaction mixture changed from light yellow to reddish orange as the reaction progressed. After 5 hrs, activated charcoal (5 g) was added and the reaction mixture was stirred for an additional 1 hr. The black heterogenous mixture was then passed over a pad of basic alumina with anhydrous pentane (500 mL) as the eluent. The colorless eluent was concentrated under vacuum to yield a colorless liquid as a pure product (4.58 g, 44%). 1H NMR of reaction product (400 MHZ, CDCl3): 4.66 (1H, Si—H), 2.37 (4H, br), 2.27 (2H, triplet), 1.64-1.38 (9H, multiplet), 0.48 (2H, triplet), 0.16 (6H, doublet), 0.08 (6H, doublet).

### Example 1-1. Synthesis of Control SBR Based Polymer Containing 40% Styrene

A nitrogen purged jacketed steel reactor was charged with 3.53 lbs of anhydrous hexane, 1.68 lbs of a 32.2 wt. % styrene in hexane, and 4.57 lbs of a 21.0 wt. % butadiene in hexane. The jacket temperature of the reactor was set to 145° F. and the reactor was then charged with a mixture of n-butyllithium (3.49 mL, 1.6 M in hexane, 0.820 mmol per hundred gram monomer) and hexamethyleneimine (HMI) (1.67 mL, 3.0M in cyclohexane 0.9 equiv. vs Li), followed by 2,2-bis(2′-tetrahydrofuryl) propane (0.14 mL, 1.6 M in hexane, 0.04 equiv vs Li), and potassium tert-amylate (0.39 mL, 0.90M in cyclohexane, 0.078 equiv. vs Li). The batch temperature peaked at 177.1° F. after 38 minutes. Tin tetrachloride (0.91 mL, 1.0M in heptane, 0.163 equiv. vs Li) was charged into the reactor at peak temperature. After an additional 30 minutes, the polymerization was quenched by dropping the polymer cement into a bucket containing ˜8 L isopropyl alcohol and 15 g of 2,6-di-tert-butyl-4-methylphenol. The polymer was coagulated and drum dried. The polymer was analyzed by GPC, NMR, DSC, and TN analysis with those values reported in Table 2.

### Example 1-2. Synthesis of SBR-g-TMDSpropylpiperidine in THF

To SBR (50 g) dissolved in THF to a total volume of 600 mL was added the silylating agent (5 wt. %, 2.5 g, 9.63 mmols), and platinum (0)-1,3-divinyl-1,1,3,3-tetramethyldisiloxane complex solution in xylene Pt ˜2% (1 mL). The bottle was agitated in a 50° C. water bath for 8 hrs, and the bottle was quenched with 3 mL of an IPA/BHT solution (˜0.1 g BHT/mL IPA solution) and poured into a bucket containing IPA/BHT solution, coagulated and drum dried. The polymer was analyzed by GPC, NMR, DSC, TN methods with those values reported in Table 2.

### Example 1-3. Synthesis of SBR-g-TMDSpropylpiperidine in Hexane

To SBR (50 g) dissolved in hexane to a total volume of 600 mL was added the silylating agent (5 wt. %, 2.5 g, 9.63 mmols), and platinum (0)-1,3-divinyl-1,1,3,3-tetramethyldisiloxane complex solution in xylene Pt ˜2% (1 mL). The bottle was agitated in an 80° C. water bath overnight, and the bottle was quenched with 3 mL of an IPA/BHT solution (˜0.1 g BHT/mL IPA solution) and poured into a bucket containing IPA/BHT solution, coagulated and drum dried. The polymer was analyzed by GPC, NMR, DSC, TN methods with those values reported in Table 2.

### Example 1-4. Synthesis of SBR-g-TMDSpropylpiperidine in Toluene

To SBR dissolved in toluene to a total volume of 600 mL was added the silylating agent (5 wt. %, 2.5 g, 9.63 mmols), and platinum (0)-1,3-divinyl-1,1,3,3-tetramethyldisiloxane complex solution in xylene Pt ˜2% (1 mL). The bottle was agitated in an 80° C. water bath overnight, and the bottle was quenched with 3 mL of an IPA/BHT solution (˜0.1 g BHT/mL IPA solution) and poured into a bucket containing IPA/BHT solution, coagulated and drum dried. The polymer was analyzed by GPC, NMR, DSC, TN methods with those values reported in Table 2.

TABLE 2
Analytical characteristics of polymers (Example 1-4)

| Example | 1-1 | 1-2 | 1-3 | 1-4 |
|---|---|---|---|---|
| Solvent for hydrosilylation | N/A | THF | Hexane | Toluene |
| Total Nitrogen (ppm) | 55 | 617 | 1800 | 2271 |
| GPC Base peak | | | | |
| Mn (PS Std; g/mol) | 155417 | 161133 | 104801 | 129579 |
| Mw (PS Std; g/mol) | 194571 | 196260 | 187480 | 191656 |
| Mw/Mn (PS Std) | 1.252 | 1.218 | 1.789 | 1.479 |
| GPC-Coupled peak | | | | |
| Mn (PS Std; g/mol) | 704120 | 524753 | 561907 | 514508 |
| Mw (PS Std; g/mol) | 861751 | 643542 | 716985 | 612761 |
| Mw/Mn (PS Std) | 1.224 | 1.226 | 1.276 | 1.191 |
| GPC Total | | | | |
| Mn (PS Std; g/mol) | 262161 | 203766 | 150317 | 168601 |
| Mw (PS Std; g/mol) | 543172 | 331313 | 384674 | 321929 |
| Mw/Mn (PS Std) | 2.072 | 1.626 | 2.558 | 1.909 |
| Wt. % Styrene | 40.8 | 41 | 40.9 | 41 |
| Wt. % 1,2 butadiene (BD = 100) | 20.5 | 18.7 | 18.9 | 18.4 |
| Wt. % 1,4 butadiene (BD = 100) | 79.6 | 81.3 | 81.1 | 18.6 |
| Tg (° C.) | NA | −45.3 | −45.8 | −46.6 |
| ML(1 + 4) | 84.4 | 67.9 | 74 | 63.2 |
| T80 | 4.5 | 3 | 10.1 | 3.5 |

Table 2 shows the analytical results that were characterized by GPC, NMR, DSC and TN test methods. Example 1-1 represents the base SBR used as a control for comparison to the hydrosilylated SBRs (Examples 1-2, 1-3, and 1-4).

### Compositions Including Silylated Polymer

Polymer compositions were mixed in a 65 g Brabender mixer using natural rubber (NR), BR, and the above SBR polymers. The master batch and remill stages were mixed at a starting temperature of 125° C. at 60 rpm for 6 min and 5 min respectively. All stocks were mixed between 150° C.-160° C. for about 2-3 mins during masterbatch to achieve silanization step. The final stage was mixed at a starting temperature of 90° C. at 50 rpm for 2 min. The green rubber was cured at 145° C. for 33 min based upon MDR torque measurements.

In accordance with the patent statutes, the best mode and preferred embodiment have been set forth; the scope of the invention is not limited thereto, but rather by the scope of the attached claims.

What is claimed is:

1. A curable polymer composition, comprising:
a silylated polydiene polymer comprising a reaction product of i) a polydiene and ii) a silylating grafting agent having the formula: 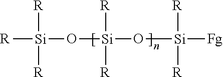
wherein n is an integer from 0 to 150, and each R individually is a hydrogen atom, a halogen atom, Fg, or a monovalent organic group, or where two or more R groups join to form a bond or a polyvalent organic group, with the proviso that at least one R is a hydrogen atom;
wherein Fg is derived from a compound having the formula CH₂═C(R₁)(R₂), wherein at least one of R₁ and R₂ have a functionality that may participate in hydrogen bonding, a chemical reaction with a filler or polymer grafting and one of R, and R₂ may be a hydrogen atom or an organic group, or 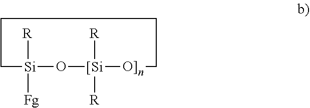
wherein R is a hydrogen atom, a halogen atom, Fg or a monovalent organic group, Fg is as defined above, and n is 2 to 5;
a non-silylated polydiene polymer comprising one or more of natural rubber, styrene-butadiene copolymer, and poly(1,3-butadiene); and
a filler comprising one or more of carbon black and silica.

2. The composition according to claim 1, wherein the silylated polydiene polymer comprises one or more of a) a copolymer of butadiene and a comonomer that is one or more of an aromatic vinyl compound and a conjugated diene; and b) poly(1,3-butadiene).

3. The composition according to claim 2, wherein the aromatic vinyl compound is styrene, 2-methylstyrene, 3-methylstyrene, 4-methylstyrene, 2,4-dimethylstyrene, 2,4,6-trimethylstyrene, alpha-methylstyrene, 2,4-diisopropylstyrene, 4-tert-butylstyrene, stilbene, vinyl benzyl dimethylamine, (4-vinylbenzyl)dimethyl aminoethyl ether, N,N-dimethylaminoethyl styrene, tert-butoxystyrene, vinylpyridine, 1,2-divinylbenzene, 1,3-divinylbenzene or 1,4-divinylbenzene, or a combination thereof, wherein the aromatic vinyl compound constitutes from 0 to 50 wt. % of the total monomer content of the copolymer, wherein the conjugated diene is isoprene, 2,3-dimethyl-1,3-butadiene, 1,3-pentadiene, 2,4-hexadiene, 1,3-hexadiene, 1,3-heptadiene, 1,3-octadiene, 2-methyl-2,4-pentadiene, cyclopentadiene, 2,4-hexadiene, 1,3-cyclohexadiene or 1,3-cyclooctadiene, or a combination thereof.

4. The composition according to claim 2, wherein the copolymer is a styrene-butadiene copolymer, a poly(butadiene) homopolymer, a butadiene-isoprene copolymer or a styrene-isoprene-butadiene copolymer, with a styrene content of from 5 to 50% by weight of total monomer content of the copolymer.

5. The composition according to claim 1, wherein the filler is present in an amount from about 1 part to about 110 parts based on 100 total parts by weight of the silylated polydiene polymer and the non-silylated polydiene polymer.

6. The composition according to claim 1, wherein the non-silylated polydiene polymer further includes one or more of butyl rubber, polybutadiene, synthetic polyisoprene, polyisoprene and ethylene-diene copolymer, a styrene-butadiene copolymer, a butadiene-isoprene copolymer, a styrene-isoprene copolymer, a styrene-isoprene-butadiene copolymer, and ethylene-butadiene copolymer.

7. The composition according to claim 1, wherein the silylated polydiene polymer is present in an amount from about 10 parts to about 75 parts based on 100 total parts by weight of the silylated polydiene polymer and the non-silylated polydiene polymer.

8. The composition according to claim 1, wherein the non-silylated polydiene polymer comprises two or more different polymers.

9. The composition according to claim 8, wherein the non-silylated polydiene polymer comprises butyl rubber, poly(butadiene), natural rubber, and styrene-butadiene copolymer.

10. The composition according to claim 1, wherein the silylated polydiene polymer is present in an amount from about 15 parts to about 50 parts based on 100 total parts by weight of the silylated polydiene polymer and the non-silylated polydiene polymer.

11. The composition according to claim 1, wherein the silylated polydiene polymer has a main chain grafted nitrogen-containing functional group concentration that varies from about 50 ppm to about 2000 ppm.

12. The composition according to claim 1, wherein the filler comprises silica in an amount from about 1 part to about 120 parts by weight based on 100 parts by weight of total polymer.

13. The composition according to claim 1, wherein the polymer has a weight average molecular weight of about 75,000 g/mol to about 1,000,000 g/mol.

14. The composition according to claim 1, wherein the polymer has a number average molecular weight of about 75,000 g/mol to about 1,000,000 g/mol.

15. A tire comprising the composition according to claim 1.

16. A cured polymer composition which is obtained by curing the polymer composition according to claim 1.

17. An article comprising at least one component formed from the vulcanized polymer composition according to claim 16.

18. A method for curing the curable polymer composition according to claim 1, comprising the steps of:
obtaining the polymer composition; and
curing the polymer composition utilizing a curative.
